(19) United States
(12) Patent Application Publication
(10) Pub. No.: US 2009/0040400 A1
(43) Pub. Date: Feb. 12, 2009

(54) LIQUID CRYSTAL DISPLAY DEVICE AND LIQUID CRYSTAL PROJECTOR

(75) Inventors: Kenichi Nakagawa, Shizuoka (JP); Makoto Yamada, Kanagawa (JP); Toshitaka Ninomiya, Kanagawa (JP); Koichi Sugihara, Kanagawa (JP); Shintaro Washizu, Tokyo (JP); Masao Sato, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/994,600

(22) PCT Filed: Jul. 3, 2006
(86) PCT No.: PCT/JP2006/313618

§ 371 Date: May 8, 2008

(30) Foreign Application Priority Data
Jul. 5, 2005 (JP) 2005-195880

(51) Int. Cl. G02F 1/13363; G02F 1/1333

(52) U.S. Cl. 349/5; 349/117

(57) ABSTRACT

A liquid crystal display panel (11R) is provided with, from a light source side, a MLA substrate (31) having a microlens array (37), an opposed substrate (32) having transparent common electrodes (41) formed thereon, a liquid crystal layer (33), and a TFT substrate (34) having transparent pixel electrodes associated with each pixel. The microlens array focuses the incident light onto the corresponding pixel electrodes. A light source side surface of the opposed substrate is provided with a retardation compensation layer (39). Since the light passes through the retardation compensation layer and the liquid crystal layer at the same angle even if the light diffracts and diffuses on the microlens array, leakage of light is prevented.

### TECHNICAL FIELD

The present invention relates to liquid crystal display devices and liquid crystal projectors of TFT type, and more particularly to a liquid crystal display device and a liquid crystal projector able to compensate retardation of light occurred in a liquid crystal layer.

### BACKGROUND ART

Liquid crystal devices are classified into TN (Twisted Nematic) mode, VA (Vertical Alignment) mode, IPS (In-Plane Switching) mode, OCB (Optically Compensatory Bend) mode, ECB (Electrically Controlled Birefringence) mode and so forth, based on an operating mode of a liquid crystal layer. While these operating modes differ in alignment direction of liquid crystal molecules, they are the same in function that electrically controls quantity of light passing through the liquid crystals so as to display characters and images.

One of the known liquid crystal devices is a TFT (thin film transistor) type. The TFT type liquid crystal device (TFT-LCD) uses the thin film transistors to control voltage applied to each pixel region of the liquid crystal layer. Able to provide a fast and exact switching of pixels, the TFT-LCD is widely used for high image quality applications. The TFT-LCD includes a TFT substrate having a TFT array with its wiring pattern and transparent pixel electrodes, and an opposed substrate having transparent common electrodes that correspond to the pixel electrodes of the TFT substrate. Provided between the TFT substrate and the opposed substrate is a layer of liquid crystalline material. Generally, the liquid crystal layer of the TFT-LCD is the TN mode.

The TFT substrate and the opposed substrate are both, for example, transparent glass substrates. The TFT substrate is located on a projection lens side, and the opposed substrate is located on a light source side. The opposed substrate is also provided with a matrix of light shielding layer called a black matrix, which is shaped, for the color TFT-LCDs in particular, to surround each of the pixel electrodes that constitute a mosaic pattern. While it also serves to enhance contrast of the pixels, the black matrix blocks light toward the TFTs so that the TFTs do not operate improperly upon irradiation of intense light. Further, the opposed substrate is provided with a microlens array for preventing loss of light due to the black matrix. Each microlens focuses the incident light on the corresponding pixel, and the light from the light source effectively passes through openings of the black matrix.

When used in liquid crystal projectors, the TFT-LCD needs to be small. In this case, the density of pixels has to be increased in order to project high definition images on a screen. Accordingly, the interval, or pitch, of both the electrodes and microlenses is decreased on the substrates.

For example, the microlenses and the TFTs are arranged at approximately 10 μm pitch. This small pitch causes diffraction in a part of the light from the light source and, as shown in FIG. 5, the light of a certain wavelength diffuses at an angle of approximately 10 degrees in every directions. As a result, the light passes through the liquid crystal layer at different angles than it does through a retardation compensation layer. Under this circumstance, the necessary retardation compensation effect is hardly obtained, and light leakage from an analyzer is occurred to lower the contrast ratio of the projected images. Such diffuse light due to the diffraction seriously hinders the retardation compensation performance, but has been unrecognized previously. It is worth noted that this effect is present in the liquid crystal display devices with a minute element structure regardless of the liquid crystal modes.

In view of the forgoing, an object of the present invention is to provide the liquid crystal display device and the liquid crystal projector able to compensate the retardation of the light that is diffused due to the diffraction.

### DISCLOSURE OF INVENTION

In order to achieve the above and other objects, a liquid crystal display device of the present invention includes a structure of minute elements arranged at a regular pitch that possibly causes diffraction of visible spectrum light, and a retardation compensation layer located between the minute element structure and a liquid crystal layer enclosed by a pair of substrates. This retardation compensation layer compensates retardation of light occurred in the liquid crystal layer.

This invention does not specify the liquid crystal mode or retardation compensating technology which should just match the liquid crystal mode.

The minute element structure is integrated with one of the substrates, and the retardation compensation layer is provided on one or both of the substrates.

A liquid crystal projector of the present invention includes the structure of minute elements arranged at a regular pitch that possibly causes diffraction of visible spectrum light, the liquid crystal layer enclosed by the pair of substrates, and a retardation compensation layer located between the minute element structure and the liquid crystal layer so as to compensate retardation of light occurred in the liquid crystal layer.

According to the present invention, the retardation compensation layer is located closer to the liquid crystal layer than the diffraction-causing minute element structure is. This arrangement allows light to pass through the retardation compensation layer and the liquid crystal layer at the same angle, and therefore the retardation of light occurred in the liquid crystal layer is precisely compensated. Light leakage in the black display state is thereby prevented, and the liquid crystal display device becomes to provide an enhanced contrast ratio, a wider viewing angle, and uniform brightness. In particular, the present invention is effective to the small sized, high pixel-density liquid crystal display devices such as those used in the liquid crystal projectors. Since the retardation compensation layer is integrated with the substrate pair that holds the liquid crystal layer, a dedicated substrate for the retardation compensation layer is not required. It is therefore possible to reduce the number of components and also the thickness of the liquid crystal display device.

### BRIEF DESCRIPTION OF DRAWINGS

FIG. 1 is a schematic view of a liquid crystal projector according to the present invention;

FIG. 2 is a cross sectional view of a liquid crystal display device according to the present invention;

FIG. 3 is a perspective view illustrating a configuration of the liquid crystal display device;

FIG. 4 is a perspective view illustrating a configuration of the liquid crystal display device in another embodiment; and

FIG. 5 is a perspective view illustrating a configuration of a conventional liquid crystal display device.

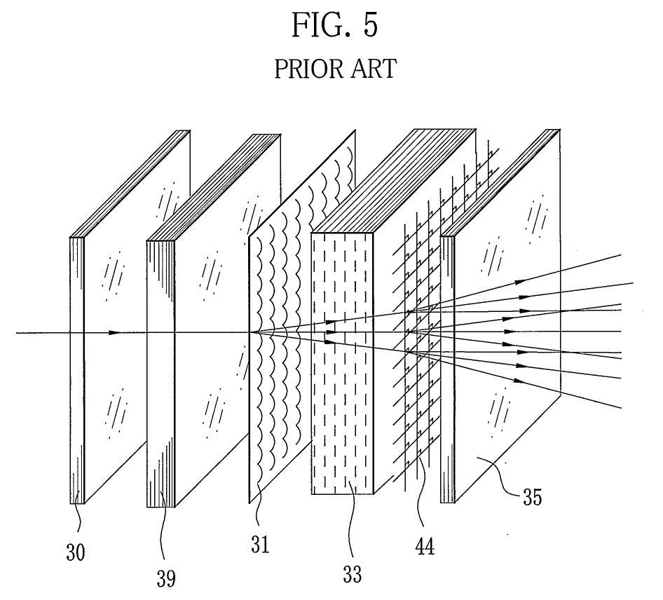

### BEST MODE FOR CARRYING OUT THE INVENTION

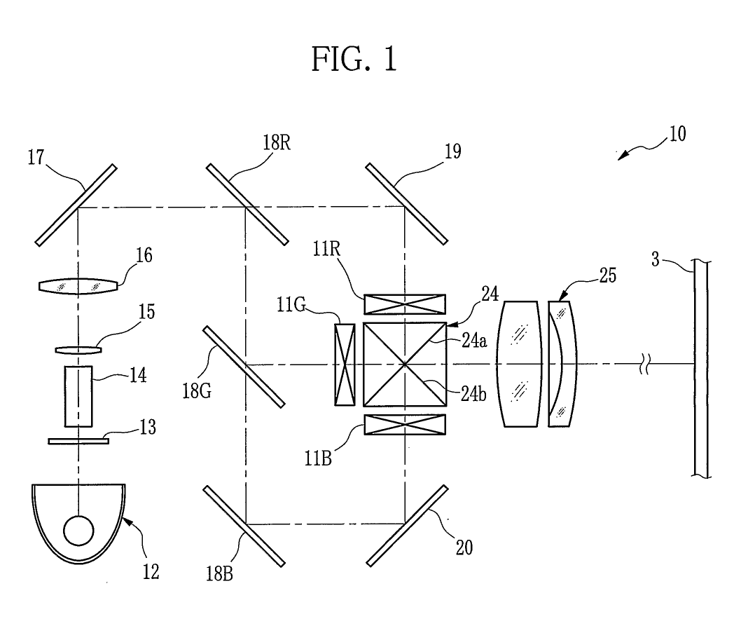

In FIG. 1, a liquid crystal projector 10 has three liquid crystal display panels 11R, 11G, and 11B of transmissive type to project full color images on a screen 3. White light irradiated by a light source 12 loses ultraviolet and infrared components when passing through a filter 13. Then, the white light passes through a glass rod 14 and has uniform intensity distribution.

The white light that comes out of the glass rod 14 becomes a parallel beam when passing through a relay lens 15 and a collimate lens 16, and proceeds to a mirror 17. Reflected on the mirror 17, the white light is divided into two beams of red and cyan by a dichroic mirror 18R which only transmits red light. The red light that transmits the dichroic mirror 18R is reflected on a mirror 19 and enters the liquid crystal display panel 11R.

The cyan light, which has been reflected on the dichroic mirror 18R, is further divided into two beams of green and blue by a dichroic mirror 18G which reflects green light. The green light that is reflected on the dichroic mirror 18G enters the liquid crystal display panel 11G. On the other hand, the blue light that transmits the dichroic mirror 18G is reflected on mirrors 18B, 20, and enters the liquid crystal display panel 11B.

The liquid crystal display panels 11R, 11G, and 11B separately display gray scale images for red color, green color, and blue color images. In addition, there is a composite prism 24 placed at equal distances from the liquid crystal display panels 11R, 11G, and 11B. The red light, the green light, and the blue light pass through the corresponding liquid crystal display panels 11R, 11G, and 11B, and are modulated into image light which carries image information. These image lights of three colors are combined into a single composite light beam by the composite prism having two dichroic surfaces 24a and 24b. The composite image light is projected through a projection lens 25 onto the screen 3, and a full color image is displayed.

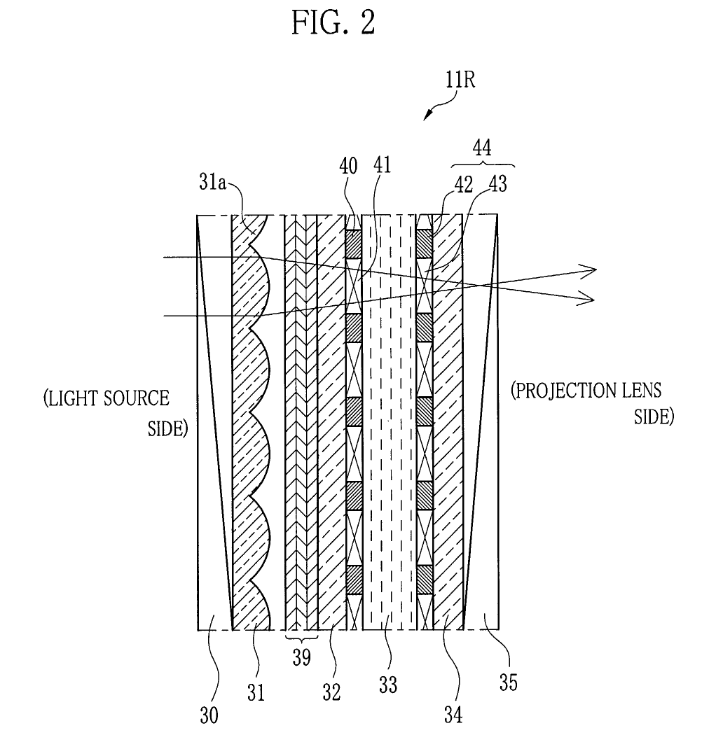

As shown in FIG. 2, the liquid crystal display panel 11R has, from the light source side, a first polarizer 30, a MLA (microlens array) substrate 31, an opposed substrate 32, a TFT substrate 34, and a second polarizer 35, which are integrated into a single component. Alternatively, the polarizers may be placed separately to avoid heat accumulation. Filled between the MLA substrate 31 and the opposed substrate 32 are liquid crystals which form a liquid crystal layer 33. The first polarizer 30 and the second polarizer 35 are in crossed nicols arrangement, where absorption axes thereof are perpendicular to each other. The first polarizer 30 converts the incident light into linearly polarized light. The second polarizer 35 regulates the passage of the linearly polarized light that has passed through the liquid crystal display panel 11R. This configuration is the same in the liquid crystal display panels 11G and 11B.

The MLA substrate 31 has a microlens array composed of plural microlenses 31a in a matrix arrangement. The microlenses 31a, each of which functions as a convex lens that condenses the incident light coming from the light source, are arranged at an approximately 10 μm pitch so that they are separately associated with each single pixel. The opposed substrate 32 has a retardation compensation layer 39, which compensates the retardation of light occurred in the liquid crystal layer 33. Additionally, a projection lens side surface of the opposed substrate 32 is provided with a black matrix 40 made of, for example, a chromium film functioning as a light shielding layer, and transparent common electrodes 41.

Formed on a light source side surface of the TFT substrate 34 is a TFT circuit pattern 44, where thin film transistors (TFT) 42 and pixel electrodes 43 are arranged in a matrix form. When the TFT 42 is turned on, a voltage is applied across the pixel electrode 43 and the common electrode 41, and thereby an alignment direction of each liquid crystal molecule is changed in the liquid crystal layer 33. In addition, between the common electrodes 41 and the liquid crystal layer 33 and between the pixel electrodes 43 and the liquid crystal layer 33, there are provided alignment films (not shown) which align the liquid crystal molecules in a certain direction when no voltage is applied.

An example of the liquid crystal layer 33 is a widely used TN mode liquid crystal layer, in which the liquid crystal molecules between the opposed substrate 32 and the TFT substrate 34 are aligned parallel to the substrate surfaces while twisted up to 90 degrees. When no voltage is applied, the linearly polarized light that passed through the first polarizer 30 is twisted 90 degrees in the liquid crystal layer 33 and passes through the second polarizer 35. Therefore, the liquid crystal display panel turns into a white display state. When voltage is applied, the liquid crystal molecules are aligned almost vertical to the substrate surfaces. The linearly polarized light that passed through the first polarizer 30 goes through the liquid crystal layer 33 with its polarization plane untwisted and is then blocked by the second polarizer 35. Therefore, the liquid crystal display panel turns into a black display state.

An example of the retardation compensation layer 39 is a layer of polymerized discotic liquid crystal compounds having a disk-like molecule structure. The discotic liquid crystal compounds in the retardation compensation layer 39 take a hybrid alignment whose alignment direction varies continuously with respect to the thickness direction of the layer. In this embodiment, the retardation compensation layer 39 is composed of three layers. In the liquid crystal layer 33 with voltage applied thereto (the black display state), the liquid crystal molecules are in the hybrid alignment that they exist vertical to the substrate surfaces in the middle of the layer while continuously increase their tilt angles toward the periphery of the substrates. This means that the retardation of light occurred in such TN liquid crystal layer can be compensated by the discotic liquid crystal layer with the hybrid alignment. Other retardation compensating means can also be applied such as polymerized rod-like molecules, an organic form birefringent layer, or an inorganic form birefringent layer.

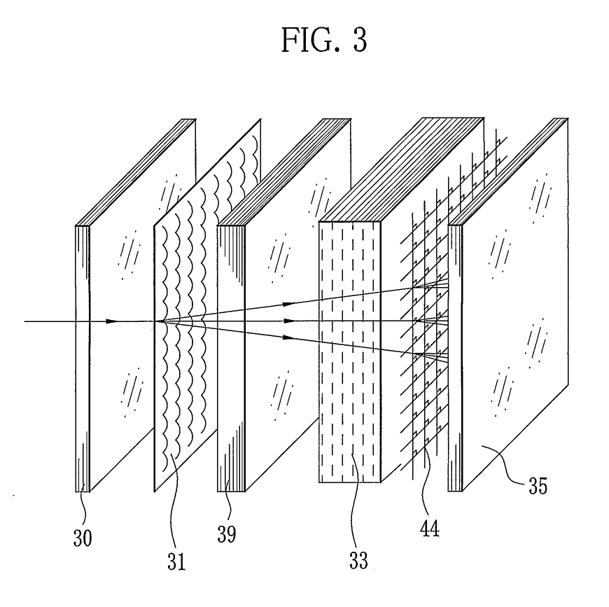

Next, the operation of the present invention is described. In FIG. 3, the incident light to the liquid crystal display panel 11R turns into linearly polarized light as it passes through the first polarizer 30, and goes through both the MLA substrate 31 with the microlens array and the retardation compensation layer 39, and then enters the liquid crystal layer 33. A part of the linearly polarized light diffracts to diffuse as it passes through the microlens array. Each ray of such diffuse light is also subjected to retardation in the retardation compensation layer 39. As a result, the light becomes to pass through the retardation compensation layer 39 and the liquid crystal layer 33 at the same angle, and the retardation of light is therefore compensated precisely.

The light that passed through the liquid crystal layer 33 partially diffracts to diffuse on the latticed TFT circuit pattern 44. However, this diffuse light hardly passes through the second polarizer 35 because the retardation of light in the liquid crystal layer 33 has been precisely compensated by the retardation compensation layer 39. Therefore, a superior black display state can be created.

As described so far, in the liquid crystal display panel 11R, the incident angle of the light to the liquid crystal layer 33 is identical to the incident angle to the retardation compensation layer 39. Therefore, excellent retardation compensation effect is achieved even if the light diffracts on either the microlens array which exhibits a refractive index difference on the interface or on the opaque TFT circuit pattern 44. This serves to improve the extinction ratio (contrast) of the display image.

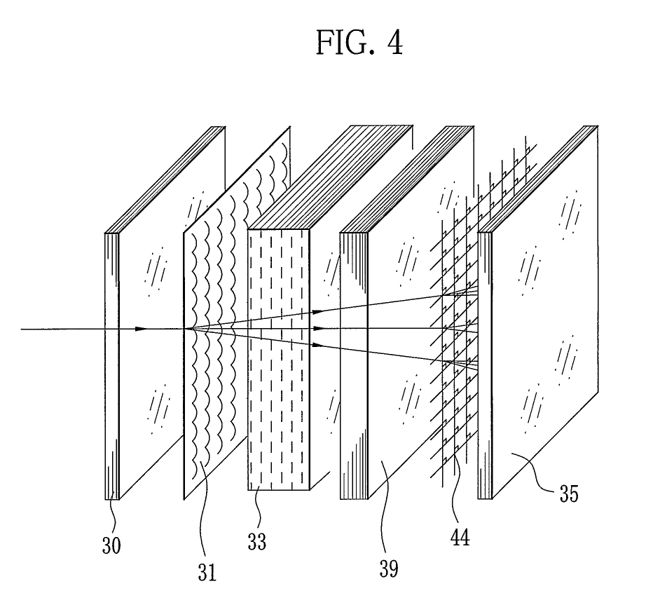

The location of the retardation compensation layer 39 is not limited to the above embodiment. For example, the retardation compensation layer 39 may be located between the liquid crystal layer 33 (more properly, the alignment film adjacent to the TFT substrate 34) and the TFT circuit pattern 44, as shown in FIG. 4, and it can still provide the same effect. Instead, if the black matrix 40 causes the diffraction of light, the retardation compensation layer 39 may be located between the wiring pattern of the common electrodes 41 and the liquid crystal layer 33 (more properly, the alignment film adjacent to the opposed substrate 32). Namely, the retardation compensation layer should be located closer to the liquid crystal layer than a diffraction-causing structure is.

The liquid crystal display device of the present invention is also applicable to a color liquid crystal projector with, for example, a single liquid crystal display panel and a color mosaic filter. In addition, the liquid crystal layer 33 is not limited to the TN mode, but may have another operating mode. In this case, the retardation compensation layer is tailored for the selected operating mode.

For example, if the liquid crystal layer is a VAN mode liquid crystal layer in which nematic liquid crystal molecules are aligned vertical to the substrate surfaces when no voltage is applied thereto, the retardation compensation layer 39 is to have an optical axis vertical to the substrate surfaces and function as a C-plate for providing uniaxial birefringence. In order to compensate positive retardation induced by the VAN mode liquid crystal, this C-plate is configured to exhibit negative refractive index anisotropy. A preferable C-plate is, for example, a form birefringence made by layering inorganic materials with high and low refractive indices alternately. Furthermore, if an A-plate having an optical axis parallel to the substrate surface and an O-plate having an optical axis oblique to the substrate surface are layered along with the C-plate, the retardation of light in the VAN mode liquid crystal layer can be compensated more effectively.

The effect of the present invention is examined in the following tests. Firstly prepared is a TFT substrate with a wiring pattern of pixels. A laser beam is irradiated to the TFT substrate, and diffracted light is observed. Secondly prepared is a VAN mode liquid crystal cell having vertical alignment films on inner surfaces of a pair of substrates. This VAN mode liquid crystal cell is disposed between the light source and the TFT substrate, and a laser beam is irradiated to it. Again, diffracted light is observed. Thirdly prepared is a retardation compensation element that functions as a negative C-plate. The liquid crystal cell, the TFT substrate, and the retardation compensation element are arranged in this order from the light source side, and a laser beam is irradiated to them. Diffracted light is also observed and, at this time, the retardation of the zeroth-order diffracted light is compensated by the retardation compensation element while the first-order or higher-order diffracted light contains the retardation component which is not compensated completely. Finally, the constituents are rearranged in the order of the liquid crystal cell, the retardation compensation element, and the TFT substrate from the light source side. A laser beam is irradiated in the same manner and, at this time, the retardation is compensated for the first-order and higher-order diffracted light as well as the zeroth-order diffracted light.

Above mentioned experiment clearly demonstrates that it is effective to place the retardation compensation layer between the minute structure and the liquid crystal layer in order to compensate the retardation precisely.

Various changes and modifications are possible in the present invention and may be understood to be within the present invention.

### Industrial Applicability

The present invention is preferably applied to TFT type liquid crystal display devices and liquid crystal projectors having such liquid crystal display device.

1. A liquid crystal display device having a structure of minute elements arranged at a regular pitch that possibly causes diffraction of visible spectrum light, and a liquid crystal layer enclosed by a pair of substrates, said liquid crystal display device comprising:
a retardation compensation layer located between said structure and said liquid crystal layer, said retardation compensation layer compensating retardation of light occurred in said liquid crystal layer.

2. A liquid crystal display device described in claim 1, wherein said retardation compensation layer is provided on one of said substrates.

3. A liquid crystal display device described in claim 1, wherein said retardation compensation layer is provided on both of said substrates.

4. A liquid crystal display device described in claim 1, wherein said structure is integrated with one of said substrates.

5. A liquid crystal display device described in claim 4, wherein said structure has a plurality of microlenses in a matrix arrangement.

6. A liquid crystal display device described in claim 4, wherein said structure has a TFT circuit pattern.

7. A liquid crystal projector including a liquid crystal display device which has a structure of minute elements arranged at regular intervals that possibly cause diffraction of visible spectrum light, and a liquid crystal layer enclosed by a pair of substrates, said liquid crystal display device comprising:
a retardation compensation layer located between said structure and said liquid crystal layer, said retardation compensation layer compensating retardation of light occurred in said liquid crystal layer.

8. A liquid crystal projector described in claim 7, wherein said retardation compensation layer is provided on one of said substrates.

9. A liquid crystal projector described in claim 7, wherein said retardation compensation layer is provided on both of said substrates.

10. A liquid crystal projector described in claim 7, wherein said structure is integrated with one of said substrates.

11. A liquid crystal projector described in claim 10, wherein said structure has a plurality of microlenses in a matrix arrangement.

12. A liquid crystal projector described in claim 10, wherein said structure has a TFT circuit pattern.
